(19) United States
(12) Patent Application Publication
(10) Pub. No.: US 2019/0122304 A1
(43) Pub. Date: Apr. 25, 2019

(54) METHOD OF BIG DATA PRODUCT CUSTOMIZATION AND DATA PROVIDERS PROFITS SHARING

(71) Applicant: Yueh-Rurng WANG, Taipei City (TW)

(72) Inventor: Yueh-Rurng WANG, Taipei City (TW)

(21) Appl. No.: 16/171,037

(22) Filed: Oct. 25, 2018

(30) Foreign Application Priority Data
Oct. 25, 2017 (TW) 106136735

(51) Int. Cl. G06Q 40/06; G06Q 40/04; G06Q 30/02; H04L 29/08

(52) U.S. Cl. CPC G06Q 40/06; H04L 67/22; G06Q 30/0206; G06Q 40/04

(57) ABSTRACT

Disclosed is a method of big data product customization and data provider's profits sharing. The method comprises the following steps: receiving a consumption microdata, verifying whether the consumption microdata conforms to a specified data format, and storing it in a personal microdata account; classifying the consumption microdata according to a predetermined classification code; and evaluating the consumption microdata to give an interests value, and storing the interests value in a personal interests account.

### BACKGROUND

### Technical Field

The present invention relates to the technical field of computer information, in particular to a method of big data product customization and data provider's profits sharing.

### Related Art

In recent years, global information advanced countries have spent huge resources to study the data collection and analysis technology in order to follow the trend of big data product markets and the derived commercial profits models. They have produced a variety of big data products to make profits, and have sought to dominate the product trading market.

The known big data product production methods are mostly based on large amounts of historical trade data previously accumulated by enterprise operators. The enterprise operators who own such large amounts of historical trade data either operate on their own historical trade data to produce big data products, or provide the historical trade data to big data product producers for operation. Under the above circumstance, the prior art developed includes computing technologies developed for the existing databases for the manufacture of big data products or as references for improving other products, and evolution of related technologies. For example, Taiwan Patent No. 1303371 entitled “Data Processing System and Method” focuses on concurrent execution with other operating procedures, and Taiwan Patent No. 1554959 entitled “Visual Data Analysis System and Operation Method of Data Supermarket” focuses on a data analysis mechanism.

On the technical level, the basic assumptions on which conventional big data product trades are based, and the technologies developed from the basic assumptions, have become concerned objects and research targets in such a manner that enterprise operators successively collect consumer trade information (hereinafter referred to as “microdata”) from operating activities and converge it into databases and applications thereof.

As mentioned above, a conventional big data product is made up of tens of thousands of microdata, but the niche of single microdata as a product element is too weak to have the product value. Under this unfavorable condition, a single consumer cannot use microdata to trade and enter a big data product market. That is, traders in the existing big data product trading markets essentially exclude single consumers.

Therefore, both the supply and demand sides of the existing big data product markets are mostly enterprises, and they all use microdata-based big data products to make profits. However, the individual consumers who create microdata as big data product elements hardly make profits from their own microdata, since the product value of the single microdata may be next to nothing, unless big data users actively feed back.

In terms of interests, when the prior art used the data in the existing database, only the interests of enterprise operators, i.e., data holders, are involved. In the era of massive data, it is the trend to strengthen the respect for individual interests of users. The personal data protection legal system can only play a role in relief afterwards when consumer's personal data is illegally used, and the interests are unlawfully attacked, but cannot provide the consumers with the specific economic benefits of using the personal data of the interests.

### SUMMARY

In view of the above problems, an object of the present invention is to provide a method of big data product customization and data provider's profits sharing, a data collection and profits sharing system, a computer readable recording medium and a computer program product. A customer can independently contribute microdata and gather a large amount of microdata to produce a big data product, so as to gain a seller status, participate in big data product market activities and make profits.

Another object of the present invention is that after a user agrees to authorize, he can voluntarily provide microdata and authorize the use of the provided microdata to generate a big data product, so that the provided microdata has the most legitimate power source for big data product elements.

Another object of the present invention is that because the micro databases that generate big data are different types of micro databases created by different types of consumption of different types of consumers, for the purpose of big data product customization, various types of big data products that achieve the purpose are arranged and combined.

A first aspect of the present invention provides a method of big data product customization and data provider's profits sharing, applied to a data collection and profits sharing system, including the following steps:

a governing module of the data collection and profits sharing system receives a data buying and selling request sent from a user terminal, and sends a data buying and selling screen data to the user terminal according to the data buying and selling request;

the governing module receives a data selling request sent from the user terminal, and sends a microdata providing screen data to the user terminal according to the data selling request;

an interests calculation module of the data collection and profits sharing system receives a consumption microdata sent from the user terminal, verifies whether the consumption microdata conforms to a specified data format, and stores the consumption microdata in a personal microdata account of a microdata collection management module of the data collection and profits sharing system;

the interests calculation module classifies the verified consumption microdata according to a predetermined classification code, and stores the classified consumption microdata in a branch database corresponding to the classified consumption microdata among a plurality of branch databases of a central database of the data collection and profits sharing system; and

the interests calculation module evaluates the consumption microdata to give an interests value, and stores the interests value in a personal interests account of a supplier's interests and profits sharing module of the data collection and profits sharing system.

A second aspect of the present invention provides a method of big data product customization and data provider's profits sharing, applied to a data collection and profits sharing system, including the following steps:

a governing module of the data collection and profits sharing system receives a data buying request sent from a user terminal, and sends a big data product demand screen data to the user terminal according to the data buying request;

a big data cost estimation module of the data collection and profits sharing system receives a product feedback condition data sent from the user terminal, searches a consumption microdata conforming to the product feedback condition data in a central database of the data collection and profits sharing system, calculates the number of the consumption microdata that constitutes a big data product, evaluates the value of the big data product according to the number of the consumption microdata to obtain a big data value amount, and sends the number and value amount of the big data product to the user terminal;

a financial management module of the data collection and profits sharing system transmits a payment completion message to the big data cost estimation module, and the big data cost estimation module transmits the big data product to a big data tabulation module of the data collection and profits sharing system according to the payment completion message;

the big data tabulation module makes each data of the big data product into a product analysis spreadsheet and a product analysis chart, and sends the product analysis spreadsheet and the product analysis chart to the user terminal; and

the big data cost estimation module calculates a profits sharing interests value obtained from the consumption microdata that constitutes the big data product according to the evaluated big data value amount, and sends it to a personal interests account, corresponding to the consumption microdata, of the supplier's interests and profits sharing module of the data collection and profits sharing system.

A third aspect of the present invention provides a data collection and profits sharing system, including a governing module, an interests calculation module, a central database, a big data cost estimation module, a supplier's interests and profits sharing module, a financial management module and a big data tabulation module, wherein the data collection and profits sharing system implements the method of big data product customization and data provider's profits sharing as described in the first aspect or the second aspect.

A fourth aspect of the present invention provides a computer readable recording medium storing a program, wherein when a data collection and profits sharing system loads the program and executes it, the method of big data product customization and data provider's profits sharing in the first aspect or the second aspect of the present invention can be completed.

A fifth aspect of the present invention provides a computer program product storing a program, wherein when a data collection and profits sharing system loads the program and executes it, the method of big data product customization and data provider's profits sharing in the first aspect or the second aspect of the present invention can be completed.

### BRIEF DESCRIPTION OF THE DRAWINGS

FIG. 1 is a block diagram of a data collection and profits sharing system and a user terminal according to the present invention;

FIG. 2 is a flow diagram of new member join according to the present invention;

FIG. 3 shows a screen of member join to a data collection and profits sharing system 20 according to the present invention;

FIGS. 4A and 4B show membership term screens according to the present invention;

FIG. 5 shows a member registration screen according to the present invention;

FIG. 6 shows a registration success notification screen according to the present invention;

FIG. 7 is a flow diagram of a method of big data product customization and data provider's profits sharing according to the present invention;

FIG. 8 shows a member login screen according to the present invention;

FIG. 9 shows a data buying/selling screen according to the present invention;

FIG. 10 shows a microdata providing screen according to the present invention;

FIG. 11 shows a selection screen of selection methods for sending consumption microdata according to the present invention;

FIG. 12 shows a screen of a camera of a user terminal according to the present invention;

FIG. 13 shows a screen of consumption patterns according to the present invention;

FIG. 14 shows a personal interests account screen according to the present invention;

FIG. 15 shows a big data product demand screen according to the present invention;

FIG. 16 shows a screen of search result indicating no data in accordance with requirements according to the present invention;

FIG. 17 shows a special-request big data product screen according to the present invention;

FIG. 18 shows an order quotation notification screen according to the present invention;

FIG. 19 shows an order content screen according to the present invention;

FIG. 20 shows a payment screen according to the present invention;

FIG. 21 is a schematic diagram of a product analysis spreadsheet according to the present invention; and

FIG. 22 is a schematic diagram of a product analysis chart according to the present invention.

### DETAILED DESCRIPTION

In order that those of ordinary skill in the art can further understand the present invention, the preferred embodiments of the present invention are listed below, and in combination with the accompanying drawings, the content and the achieved effects of the present invention will be described in detail.

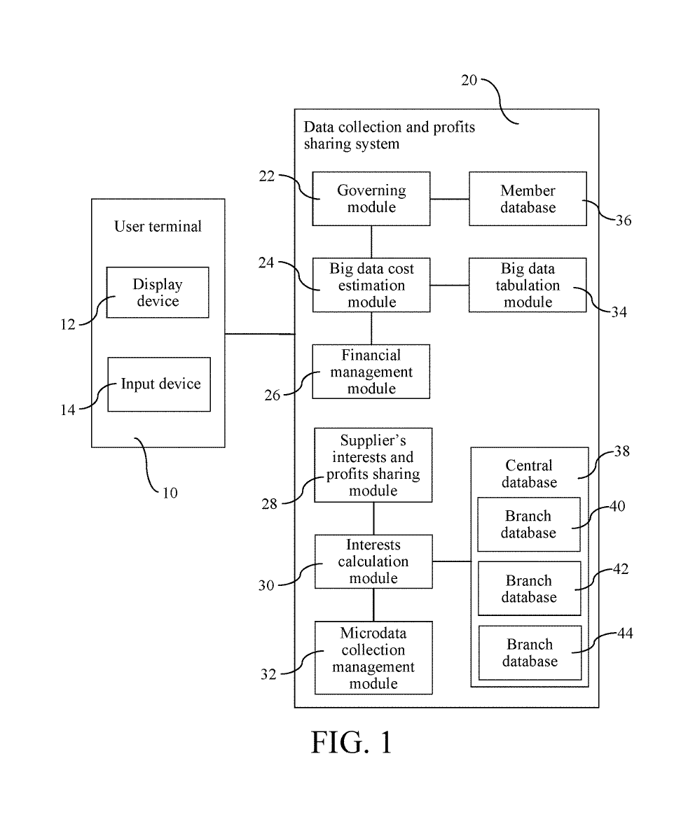

FIG. 1 is a block diagram of a data collection and profits sharing system and a user terminal according to the present invention. In FIG. 1, a user terminal 10 includes a display device 12 and an input device 14. However, the user terminal 10 also includes hardware components such as a processing unit, an interface transmission unit, a storage device and the like, which are not shown in the figure, to operate cooperatively. The user terminal 10 may be a computer, a tablet computer, a smart phone, or the like.

A data collection and profits sharing system 20 includes a governing module 22, a big data cost estimation module 24, a financial management module 26, a supplier's interests and profits sharing module 28, an interests calculation module 30, a microdata collection management module 32, a big data tabulation module 34, a member database 36 and a central database 38. The central database 38 includes a plurality of branch databases 40, 42 and 44. The branch databases 40, 42 and 44 are, for example, beverage branch databases, clothes branch databases, electronics branch databases, medical service branch databases, transportation branch databases, beauty salon branch databases, etc. In the present invention, the branch databases are not limited to the three branch databases, and any number of branch databases can be set as required.

The data collection and profits sharing system 20 also includes hardware components such as an interface transmission unit, an input device, a display device and the like, which are not shown in the figure, to operate cooperatively. Various modules in the data collection and profits sharing system 20 may be configured by software, hardware or firmware to execute the steps of a method of big data product customization and data provider's profits sharing of the present invention.

The user inputs a new member join request, an authorization message, a member data, a data buying and selling request, a data selling request and a data buying request at the input device 14 of the user terminal 10, and the user terminal 10 sends the new member join request, the authorization message, the member data, the data buying and selling request, the data selling request and the data buying request to the governing module 22 of the data collection and profits sharing system 20.

The governing module 22 sends a membership term screen data, a member registration screen data, a data buying and selling screen data, a microdata providing screen data and a big data product demand screen data to the user terminal 10 according to the new member join request, the authorization message, the data buying and selling request, the data selling request and the data buying request. The user terminal 10 receives the membership term screen data, the member registration screen data, the data buying and selling screen data, the microdata providing screen data, the big data product demand screen data, a product analysis spreadsheet and a product analysis chart, and displays a membership term screen, a member registration screen, a data buying and selling screen, a microdata providing screen and a big data product demand screen on the display device 12.

The governing module 22 receives the member data sent from the user terminal 10 and verifies whether the member data input by the user conforms to a specified format. If the member data input by the user does not conform to a specified format, i.e., the input member data is incorrect or missing, the governing module 22 sends an error message to the user terminal 10, and the display device 12 of the user terminal 10 displays the error message and instructs the user to input a correct member data. If the member data input by the user conforms to a specified format, the governing module 22 writes a member number corresponding to the member data, and stores the member number and the corresponding member data in the member database 36 of the data collection and profits sharing system 20. The member data includes name, birth date, identity card number, gender, address, phone number and email account.

The interests calculation module 30 of the data collection and profits sharing system 20 receives a consumption microdata sent from the user terminal 10 and verifies whether the consumption microdata input by the user conforms to a specified data format. If the consumption microdata input by the user does not conform to a specified data format, i.e., the input consumption microdata is incorrect or missing, the interests calculation module 30 sends an error message to the user terminal 10, and the display device 12 of the user terminal 10 displays the error message and instructs the user to input correct consumption microdata. If the consumption microdata input by the user conforms to a specified data format, the interests calculation module 30 stores the consumption microdata in a personal microdata account of the microdata collection management module 32. The consumption microdata sent from the user terminal 10 is sent in a data format or a photo file. The consumption microdata includes multiple or all of consumption time, consumption location, consumption pattern, consumption content, consumption amount and consumption quantity.

The interests calculation module 30 classifies the verified consumption microdata according to a predetermined classification code, and stores the classified consumption microdata in a branch database, corresponding to the classification of the classified consumption microdata, among the branch databases 40, 42 and 44 of the central database 38 of the data collection and profits sharing system 20, for example, in a beverage branch database, a clothes branch database, an electronics branch database, a medical service branch database, a transportation branch database or a beauty salon branch database, etc. The predetermined classification code is a Harmonized System Code (HS code).

The interests calculation module 30 evaluates the consumption microdata to give an interests value (such as bonus points or cash equivalent points), and stores the interests value in a personal interests account of the supplier's interests and profits sharing module 28 of the data collection and profits sharing system 20, wherein the personal interests account corresponds to the account of the user who provides the consumption microdata.

The big data cost estimation module 24 receives a product feedback condition data sent from the user terminal 10, e.g., a product feedback condition data about consumption region, consumer number, consumption type, consumption amount, consumer age, consumer gender or the like, searches each consumption microdata conforming to the product feedback condition data from the central database, temporarily stores each conforming consumption microdata in an offer archive, calculates the number of the conforming consumption microdata that constitutes a big data product, evaluates the value of the big data product according to the number of the consumption microdata to obtain a big data value amount, and sends the number and value amount of the big data product to the user terminal 10, to display the number and value amount of the big data product on the display device 12 for the view of the user.

When the financial management module 26 receives a payment notification that the user has paid the big data value amount, the financial management module 26 transmits a payment completion message to the big data cost estimation module 24, and the big data cost estimation module 24 transmits the big data product to the big data tabulation module 34 according to the payment completion message. The big data tabulation module 34 makes each data of each consumption microdata that constitutes the big data product in the offer archive into a product analysis spreadsheet and a product analysis chart, and sends the product analysis spreadsheet and the product analysis chart to the user terminal 10 to display the product analysis spreadsheet and the product analysis chart on the display device 12 for the user to analyze and research.

The big data cost estimation module 24 calculates a profits sharing interests value obtained from each consumption microdata that constitutes the big data product according to the evaluated big data value amount, and stores the profits sharing interests value into a personal interests account, corresponding to the user providing each consumption microdata, of the supplier's interests and profits sharing module 28.

The following illustrates various implementations, processes and specific embodiments of the present invention; and the described content covers the specific objects to be achieved by the present invention, the system structures achieving the objects as well as methods, steps, orders and the like thereof.

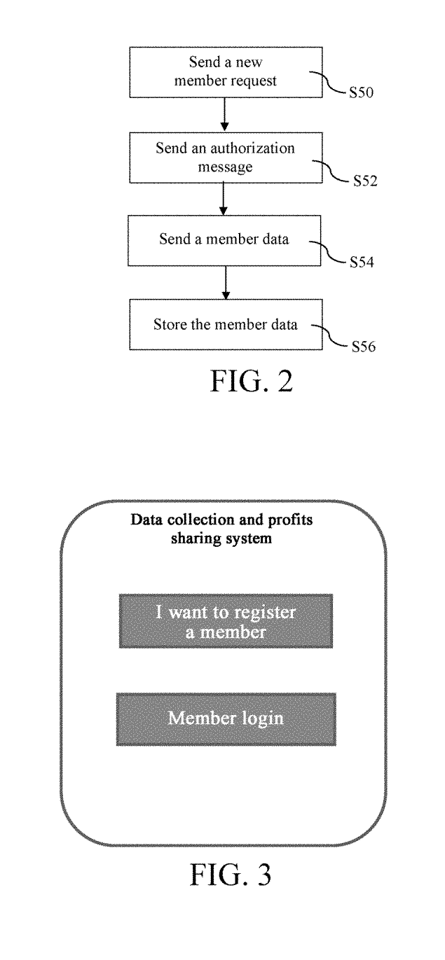

FIG. 2 is a flow diagram of new member join according to the present invention. In FIG. 2, when a user wants to join the data collection and profits sharing system 20 as a member in order to profit from consumption microdata generated by self consumption, the display device 12 of the user terminal 10 displays an APP or a login web page of member join to the data collection and profits sharing system 20, as shown in FIG. 3 which shows a screen of member join to the data collection and profits sharing system 20.

The user inputs a new member join request for joining the data collection and profits sharing system 20 to become a new member at the input device 14 of the user terminal 10, and the user terminal 10 sends the new member join request to the governing module 22 of the data collection and profits sharing system 20 (step S50).

After the governing module 22 receives the new member join request sent from the user terminal 10, the governing module 22 sends a membership term screen data to the user terminal 10 of the membership application user according to the new member join request.

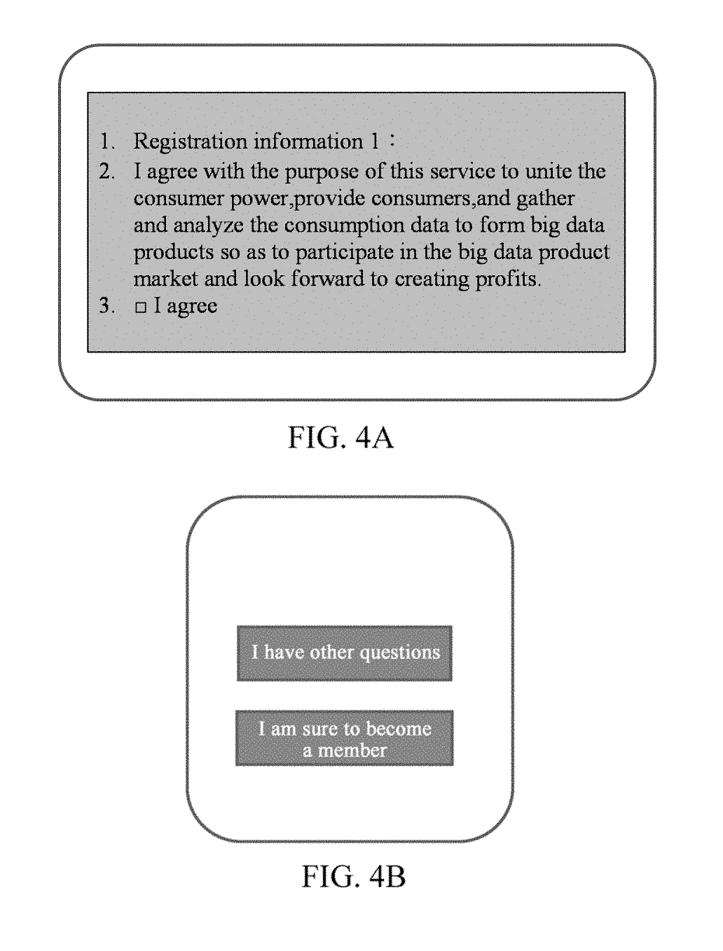

After the user terminal 10 receives the membership term screen data, the display device 12 displays a membership term screen, as shown in FIGS. 4A and 4B which show membership term screens according to the present invention. The user views the matters provided by the membership terms in the membership term screen of FIG. 4A. When agreeing to the matters provided by the membership terms, the user clicks on the option “I'm sure to become a member” through the input device 14 in FIG. 4B to generate an authorization message, and the user terminal 10 sends the authorization message to the governing module 22 (step S52).

After the governing module 22 receives the authorization message sent from the user terminal 10, the governing module 22 sends a member registration screen data to the user terminal 10 of the membership application user according to the authorization message.

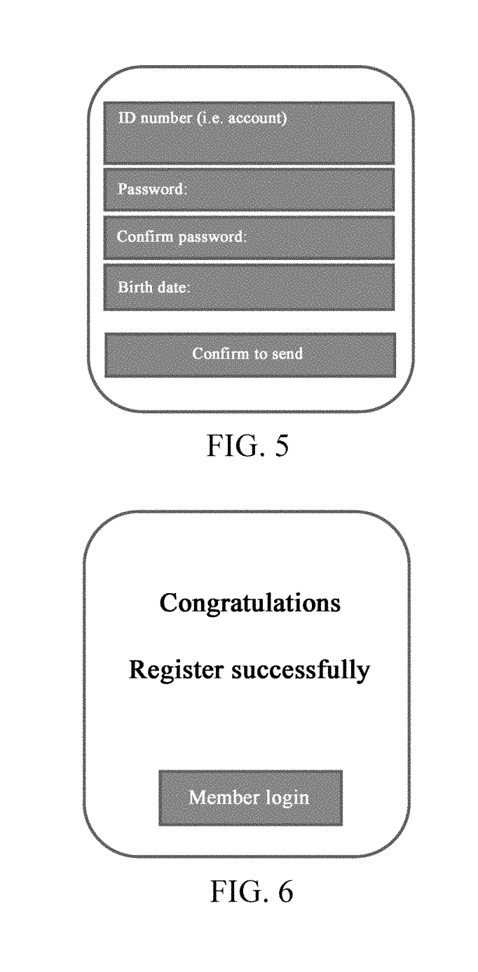

After the user terminal 10 receives the member registration screen data, the display device 12 displays a member registration screen, as shown in FIG. 5 which shows a member registration screen according to the present invention. The user inputs member data such as birth date, ID number, password and the like through the input device 14 according to the items displayed on the member registration screen. According to actual needs, the user can also input other member data such as name, gender, address, phone number, e-mail account, etc. The user terminal 10 sends the member data input by the user according to the items displayed on the member registration screen to the governing module 22 (step S54).

The governing module 22 receives the member data sent from the user terminal 10 and verifies whether the member data input by the user conforms to a specified format. If the member data input by the user does not conform to a specified format, i.e., the input member data is incorrect or missing, the governing module 22 sends an error message to the user terminal 10 of the membership application user, and the display device 12 of the user terminal 10 displays the error message and instructs the user to input a correct member data. If the member data input by the user conforms to a specified format, the governing module 22 writes a member number corresponding to the member data, and stores the member number and the corresponding member data in the member database 36 of the data collection and profits sharing system 20 (step S56).

Then, the governing module 22 sends a registration success notification screen data to the user terminal 10. After the user terminal 10 receives the registration success notification screen data, the display device 12 displays a registration success notification screen, as shown in FIG. 6 which shows a registration success notification screen according to the present invention, to notify the user that the member registration procedure is completed.

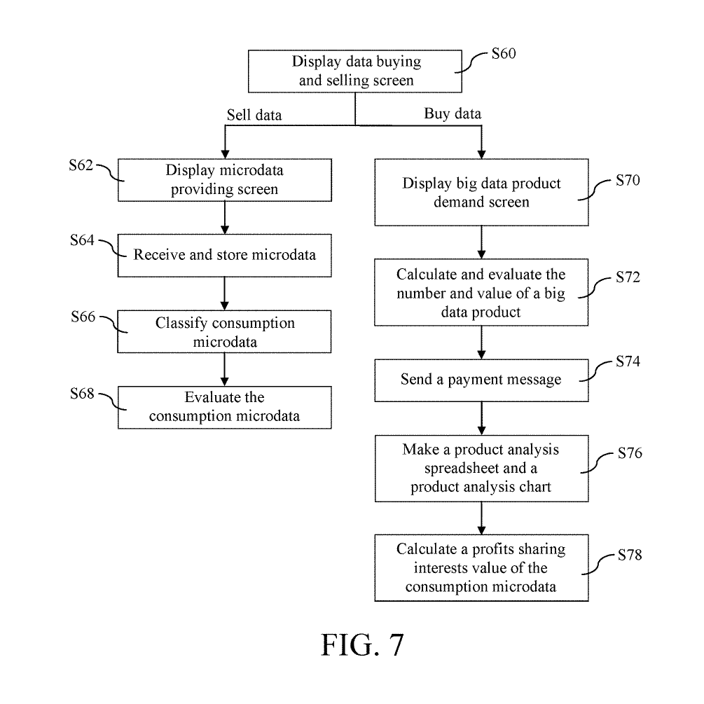

FIG. 7 is a flow diagram of a method of big data product customization and data provider's profits sharing according to the present invention. In FIG. 7, after the user becomes a member of the data collection and profits sharing system 20, the user enters the data collection and profits sharing system 20 through the user terminal 10, and the governing module 22 of the data collection and profits sharing system 20 sends a member login screen data to the user terminal 10 of the membership application user.

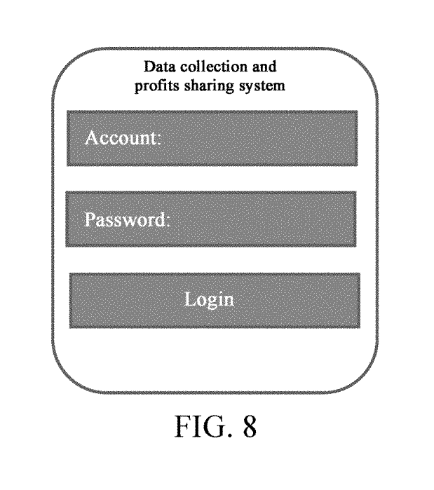

After the user terminal 10 receives the member login screen data, the display device 12 displays a member login screen, as shown in FIG. 8 which shows a member login screen according to the present invention. The user inputs an account and a password through the input device 14 of the user terminal 10, and the user terminal 10 sends the input account and password to the data collection and profits sharing system 20. The governing module 22 of the data collection and profits sharing system 20 verifies whether the account and password input by the user are correct. When the account and password input by the user are correct, the data collection and profits sharing system 20 allows the user to carry out a subsequent data buying or selling procedure.

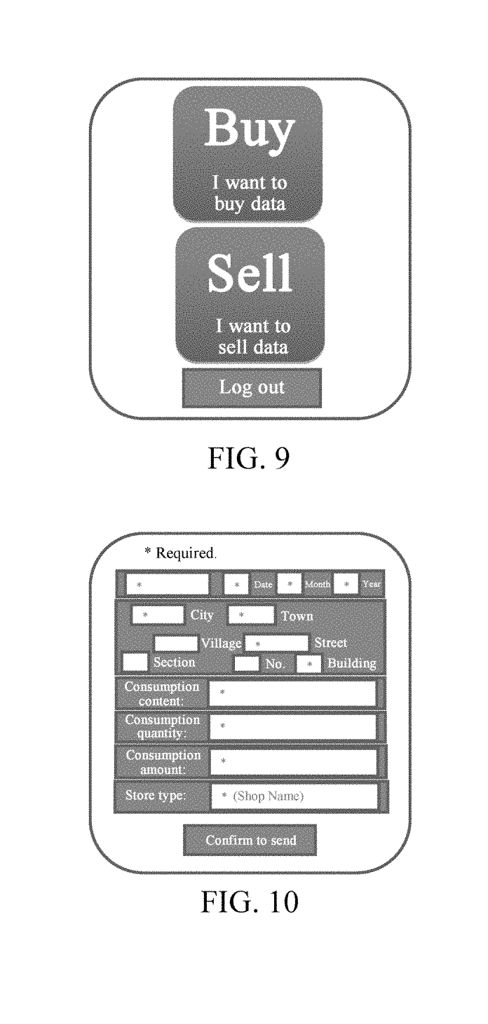

When the user wants to carry out the data buying or selling procedure, the user sends a data buying/selling request to the data collection and profits sharing system 20 through the user terminal 10, and the governing module 22 of the data collection and profits sharing system 20 sends a data buying and selling screen data to the user terminal 10 of the user who buys or sells data according to the data buying/selling request. After the user terminal 10 receives the data buying and selling screen data, the display device 12 displays a data buying and selling screen, as shown in FIG. 9 which shows a data buying/selling screen according to the present invention (step S60).

When the user wants to provide his own microdata to the data collection and profits sharing system 20 to make a big data product for sale, the user clicks the option “Sell data” on the data buying and selling screen displayed by the display device 12 through the input device 14 of the user terminal 10, and the user terminal 10 sends a data selling request to the data collection and profits sharing system 20.

After the governing module 22 of the data collection and profits sharing system 20 receives the data selling request sent from the user terminal 10, the governing module 22 sends a microdata providing screen data to the user terminal of the user who sells data according to the data selling request. After the user terminal 10 receives the microdata providing screen data, the display device 12 displays a microdata providing screen, as shown in FIG. 10 which shows a microdata providing screen according to the present invention (step S62).

The user inputs multiple or all of consumption microdata including consumption time, consumption location, consumption pattern, consumption content, consumption amount and consumption quantity on the microdata providing screen displayed by the display device 12 through the input device 14 of the user terminal 10, and the user terminal 10 sends the input multiple or all of consumption microdata including consumption time, consumption location, consumption pattern, consumption content, consumption amount and consumption quantity to the data collection and profits sharing system 20.

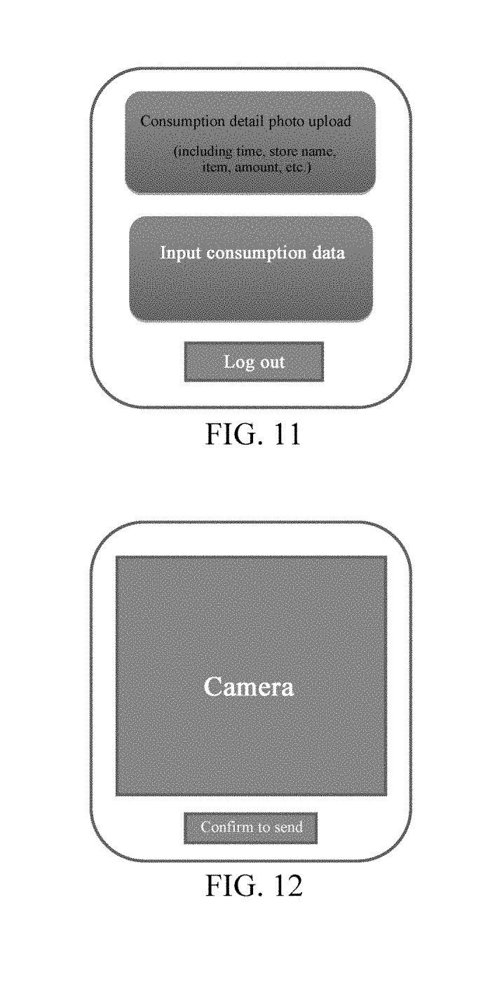

FIG. 11 shows a selection screen of selection methods according to the present invention, and FIG. 12 shows a screen of a camera of the user terminal according to the present invention. The consumption microdata sent from the user terminal 10 may be sent in a data format or photo file. The user terminal 10 displays a screen selection data sent by the data collection and profits sharing system 20 on the display device 12 as a selection screen shown in FIG. 11. When the user selects the option “Consumption detail photo upload” by means of the input device 14, the display device 12 displays the screen shown in FIG. 12, the user takes a photo of consumption details using the lens and photo function of the user terminal 10 itself to form an electronic photo file and stores it in the user terminal 10, and the user terminal 10 can send the electronic photo file of the consumption details to the data collection and profits sharing system 20 as a consumption microdata.

The interests calculation module 30 of the data collection and profits sharing system 20 receives the above-mentioned consumption microdata sent from the user terminal 10 and verifies whether the consumption microdata input by the user conforms to a specified data format. If the consumption microdata input by the user does not conform to a specified data format, i.e., the input consumption microdata is incorrect or missing, the interests calculation module 30 sends an error message to the user terminal 10 of the user sending the consumption microdata, and the display device 12 of the user terminal 10 displays the error message and instructs the user to input a correct consumption microdata. If the consumption microdata input by the user conforms to a specified data format, the interests calculation module 30 stores the consumption microdata in a personal microdata account of the microdata collection management module 32 (step S64). The personal microdata account is an account of a user who provides the consumption microdata.

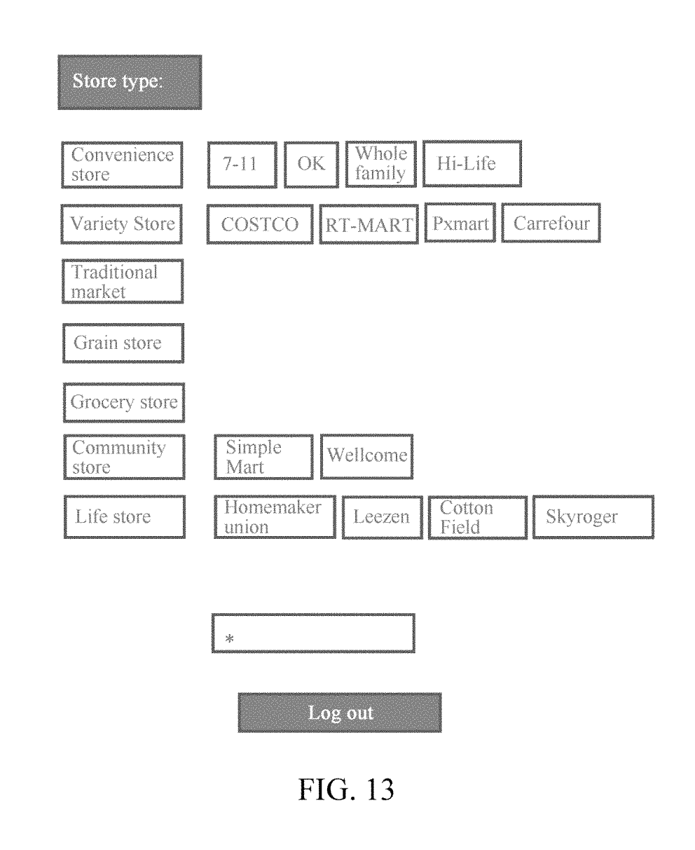

The interests calculation module 30 classifies, for example the consumption pattern (the user can click a consumption pattern screen displayed by the display device 12 as shown in FIG. 13) or consumption content in the verified consumption microdata according to a predetermined classification code such as a harmonized system code, and stores the classified consumption microdata in a branch database, corresponding to the classified consumption microdata, among the branch databases 40, 42 and 44 of the central database 38 of the data collection and profits sharing system 20, for example, in a beverage branch database, a clothes branch database, an electronics branch database, a medical service branch database, a transportation branch database or a beauty salon branch database, etc. (step S66).

The interests calculation module 30 evaluates the consumption microdata provided by the user to give an interests value (such as bonus points or cash equivalent points), and stores the interests value in a personal interests account of the supplier's interests and profits sharing module 28 of the data collection and profits sharing system 20, wherein the personal interests account corresponds to the account of the user who provides the consumption microdata (step S68).

When the user finishes providing his own microdata to the data collection and profits sharing system 20, the user can look up how much interests value the microdata provided by him produces or check the interests value accumulated by providing microdata multiple times. The user sends an interests value lookup request to the data collection and profits sharing system 20 through the user terminal 10, and the supplier's interests and profits sharing module 28 of the data collection and profits sharing system 20 sends, according to the interests value lookup request, a personal interests account screen data to the user terminal 10 of the user who looks up the interests value.

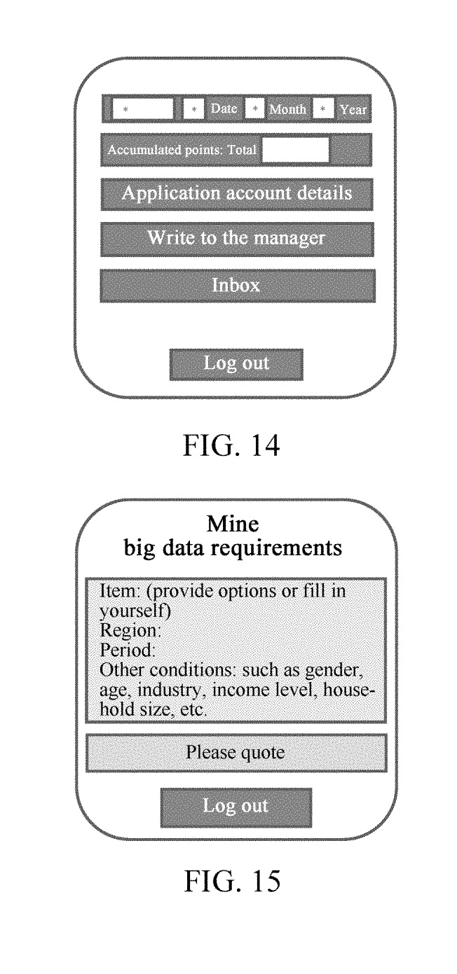

After the user terminal 10 receives the personal interests account screen data, the display device 12 displays a personal interests account notification screen, as shown in FIG. 14 which shows a personal interests account screen according to the present invention, and the user can look up the interests value produced by providing microdata every time on the personal interests account screen displayed by the display device 12.

When the user wants to buy a big data product, the user clicks the option “Buy data” on the data buying and selling screen displayed by the display device 12 through the input device 14 of the user terminal 10, and the user terminal 10 sends a data buying request to the data collection and profits sharing system 20.

After the governing module 22 of the data collection and profits sharing system 20 receives the data buying request sent from the user terminal 10, the governing module 22 sends, according to the data buying request, a big data product demand screen data to the user terminal 10 of the user who buys data. After the user terminal 10 receives the big data product demand screen data, the display device 12 displays a big data product demand screen, as shown in FIG. 15 which shows a big data product demand screen according to the present invention (step S70).

The user inputs a product feedback condition data on the big data product demand screen displayed by the display device 12 through the input device 14 of the user terminal 10, for example, inputs a product feedback condition data of consumption region, consumer number, consumption type, consumption amount, consumer age or consumer gender, etc. When the user selects the option “Please quote” on the big data product demand screen displayed by the display device 12 through the input device 14, the user terminal 10 sends the input quotation request and product feedback condition data to the data collection and profits sharing system 20.

The big data cost estimation module 24 receives the quotation request and product feedback condition data sent from the user terminal 10, searches each consumption microdata conforming to the product feedback condition data from the branch databases 40, 42 and 44 of the central database 38, temporarily stores each conforming consumption microdata in an offer archive, calculates the number of the conforming consumption microdata that constitutes a big data product, and evaluates the value of the big data product according to the number of the consumption microdata to obtain a big data value amount (step S72).

When a little or none consumption microdata conforming to the product feedback condition data is searched from the central database 38 by the big data cost estimation module 24, the big data cost estimation module 24 sends a screen data of search result indicating no data in accordance with requirements to the user terminal 10 of the user who buys data.

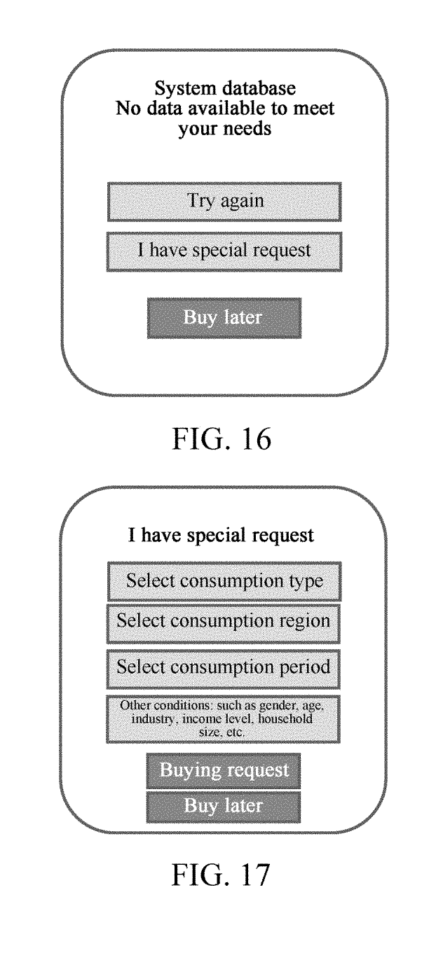

After the user terminal 10 receives the screen data of search result indicating no data in accordance with requirements, the display device 12 displays a data screen of search result indicating no data in accordance with requirements, as shown in FIG. 16 which shows a data screen of search result indicating no data in accordance with requirements according to the present invention.

When the user decides to search the same product feedback condition data again, the user clicks the option “Try again” on the data screen of search result indicating no data in accordance with requirements as displayed by the display device 12 through the input device 14 of the user terminal 10, and the user terminal 10 sends a try-again request to the data collection and profits sharing system 20. After the data collection and profits sharing system 20 receives the try-again request sent from the user terminal 10, the data collection and profits sharing system 20 implements step S72 again.

However, in the case where a little or none consumption microdata conforms to the product feedback condition data, the data collection and profits sharing system 20 provides a special request function to the user who buys data. This function is described below.

When the user determines the special request function, the user clicks the option “I have a special request” on the data screen of search result indicating no data in accordance with requirements as displayed by the display device 12 through the input device 14 of the user terminal 10, and the user terminal 10 sends a special request to the big data cost estimation module 24.

After the big data cost estimation module 24 receives the special request sent from the user terminal 10, the big data cost estimation module 24 sends a special-request big data product screen data to the user terminal 10 of the user who buys data.

After the user terminal 10 receives the special-request big data product screen data, the display device 12 displays a special-request big data product screen, as shown in FIG. 17 which shows a special-request big data product screen according to the present invention.

The user fills special request condition data about consumption region, consumer number, consumption type, consumption amount, consumer age or consumer gender and the like in the fields of “Select consumption type”, “Select consumption region”, “Select consumption period”, “Other conditions” and the like on the special-request big data product screen displayed by the display device 12 through the input device 14. Then, the user clicks the option “Special request for buying” on the special-request big data product screen displayed by the display device 12 through the input device 14, and the user terminal 10 sends a special request for buying and a special request condition data to the big data evaluation module 24.

After the big data evaluation module 24 receives the special request for buying and the special request condition data, it sends the special request condition data to the user terminals 10 of all members, and the member conforming to the special request condition data fills consumption microdata through the input device 14 and sends the consumption microdata to the big data cost estimation module.

After the big data evaluation module receives the consumption microdata sent from the user terminal of the member conforming to the special request condition data, it temporarily stores each consumption microdata in an offer archive, calculates the number of the consumption microdata that constitutes a big data product, and evaluates the value of the big data product according to the number of the consumption microdata to obtain a big data value amount.

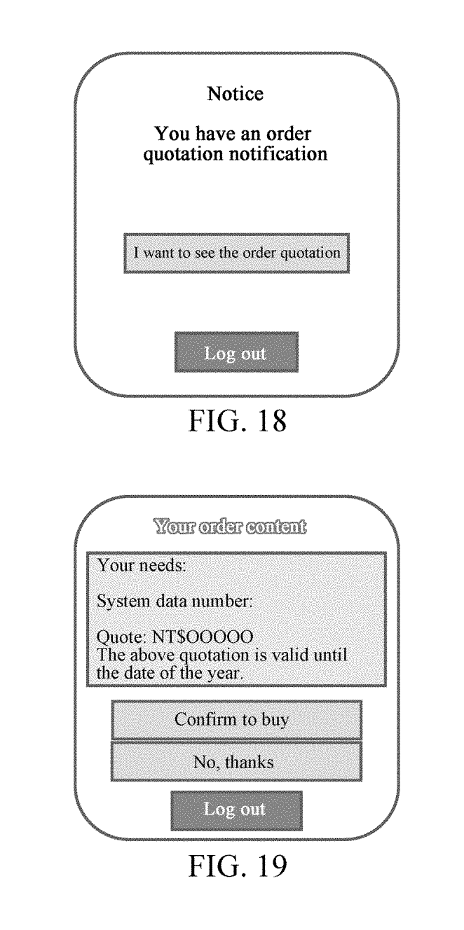

Then, the big data evaluation module 24 sends an order quotation notification screen data to the user terminal 10. After the user terminal 10 receives the order quotation notification screen data, the display device 12 displays an order quotation notification screen, as shown in FIG. 18 which shows an order quotation notification screen according to the present invention.

The user clicks the option “I want to see order quotation” on the order quotation notification screen displayed by the display device 12 through the input device 14 of the user terminal 10, and the user terminal 10 sends an order quotation viewing request to the data collection and profits sharing system 20.

The big data cost estimation module 24 of the data collection and profits sharing system 20 sends an order content screen data to the user terminal 10 according to the order quotation viewing request, wherein the order content screen data includes the number of big data products and the value amount. After the user terminal 10 receives the order content screen data, the display device 12 displays the order content screen of the data including the number of big data products and the value amount to the user to view, as shown in FIG. 19 which shows an order content screen according to the present invention.

When the user wants to buy a big data product, the user clicks the option “Confirm to buy” on the order content screen displayed by the display device 12 through the input device 14 of the user terminal 10, and the user terminal 10 sends a buying confirmation request to the data collection and profits sharing system 20.

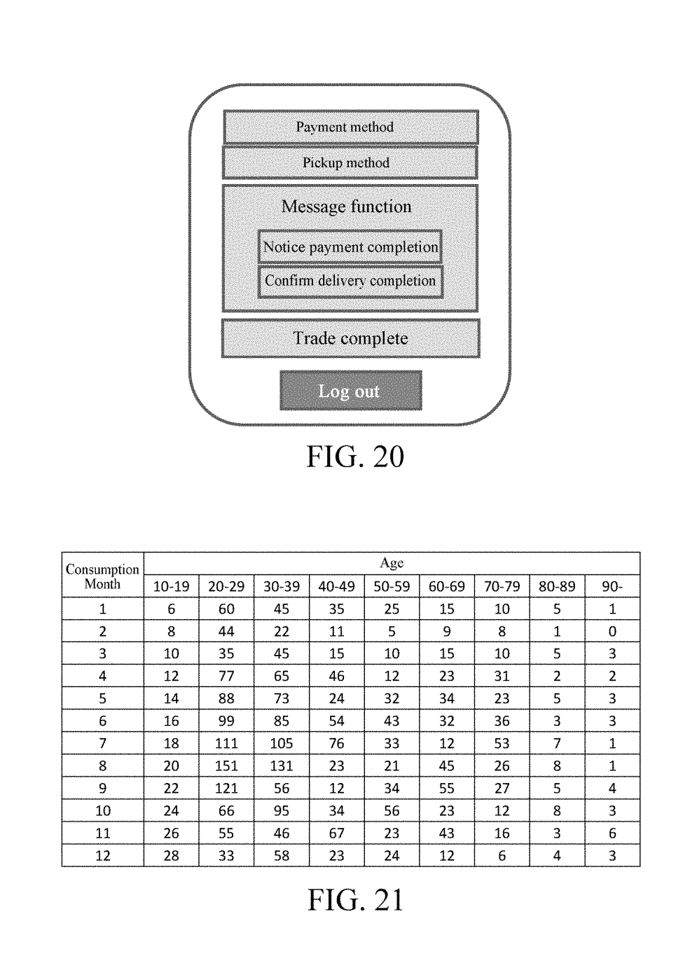

After the financial management module 26 of the data collection and profits sharing system 20 receives the buying confirmation request sent from the user terminal 10, the financial management module 26 sends a payment screen data to the user terminal 10 according to the buying confirmation request. After the user terminal 10 receives the payment screen data, the display device 12 displays a payment screen, as shown in FIG. 20 which shows a payment screen according to the present invention.

The user clicks the option “Payment method” on the payment screen displayed by the display device 12 through the input device 14 of the user terminal 10 to select on-line credit card payment or financial institution money transfer, the user clicks the option “Pickup method” on the payment screen displayed by the display device 12 through the input device 14 of the user terminal 10 to select product key delivery, e-mail or mobile phone message, then the user clicks the option “Trade completion” on the payment screen displayed by the display device 12 through the input device 14 of the user terminal 10, and the user terminal 10 sends a trade completion request, a payment method and a pickup method to the data collection and profits sharing system 20.

After the financial management module 26 of the data collection and profits sharing system 20 receives the trade completion request, the payment method and the pickup method sent from the user terminal 10, when the financial management module 26 confirms the completion of cash flow payment, the financial management module 26 transmits a payment completion message to the big data cost estimation module 24 (step S74).

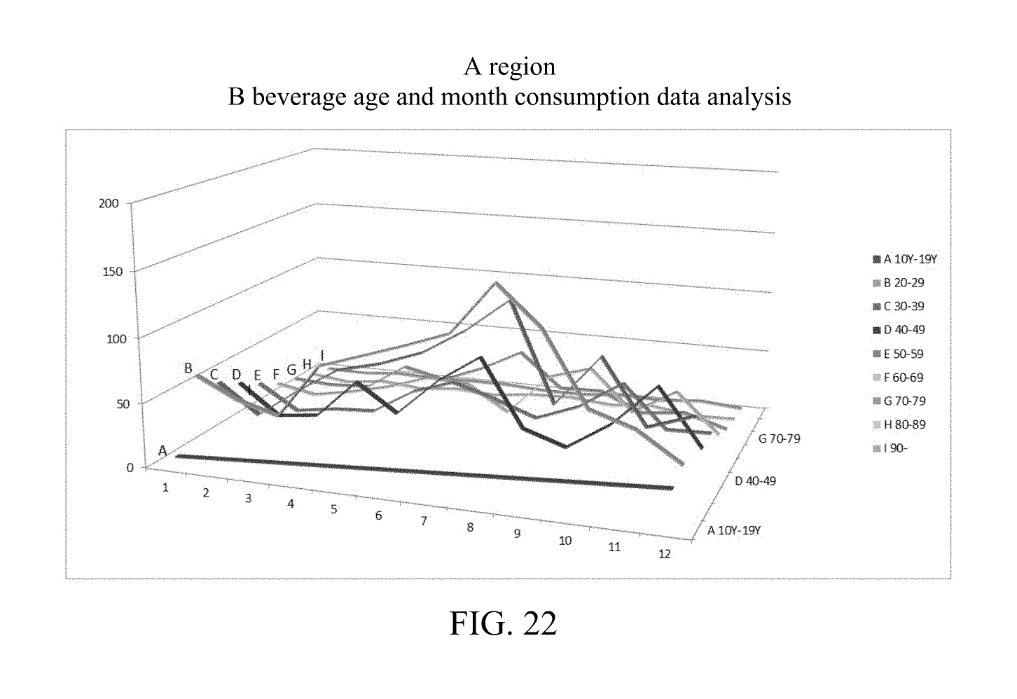

The big data cost estimation module 24 transmits the big data product to the big data tabulation module 34 according to the payment completion message. The big data tabulation module 34 makes the data (e.g., input consumption region, consumer number, consumption type, consumption amount, consumer age or consumer gender, etc.) of each consumption microdata that constitutes the big data product in the offer archive into a product analysis spreadsheet and a product analysis chart, and sends the product analysis spreadsheet and the product analysis chart to the user terminal 10, and the display device 12 displays the product analysis spreadsheet and the product analysis chart for the user to analyze and research (step S76). FIG. 21 is a schematic diagram of a product analysis spreadsheet according to the present invention and FIG. 22 is a schematic diagram of a product analysis chart according to the present invention. The data in FIG. 21 and FIG. 22 is exemplary, and the present invention is not limited thereto.

When the financial management module 26 confirms the completion of cash flow payment, the financial management module 26 also transmits a big data value amount to the big data cost estimation module 24. The big data cost estimation module 24 calculates a profits sharing interests value obtained from each consumption microdata that constitutes the big data product according to the evaluated big data value amount, and stores the profits sharing interests value into a personal interests account, corresponding to the user providing each consumption microdata, of the supplier's interests and profits sharing module 28 (step S78). The user can look up the personal interests account screen displayed by the display device 12 in FIG. 14 to view the profits sharing interests value generated by selling the microdata.

The method of big data product customization and data provider's profits sharing according to the present invention can be written in a program, and the program can be stored in a computer readable recording medium. When the data collection and profits sharing system loads and executes the program in the recording medium, the method steps as described above and shown in the drawings can be completed.

The method of big data product customization and data provider's profits sharing according to the present invention can be completed by a computer program product with a program stored therein. When the data collection and profits sharing system loads the program from, for example, the network and executes it, the method steps as described above and shown in the drawings can be completed.

The invention provides a method of big data product customization and data provider's profits sharing, a data collection and profits sharing system, a computer readable recording medium and a computer program product, which are characterized in that a customer can independently contribute microdata and gather a large amount of microdata to produce a big data product, so as to gain a seller status, participate in big data product market activities and make profits.

Although the present invention has been described above with reference to the preferred embodiments and the accompanying drawings, the present invention is not limited thereto. Various modifications, omissions and changes made to the forms and specific embodiments of the present invention by those skilled in the art should fall into the scope of the present invention.

### SYMBOL DESCRIPTION

10 user terminal

12 display device

14 input device

20 data collection and profits sharing system

22 governing module

24 big data cost estimation module

26 financial management module

28 supplier's interests and profits sharing module

30 interests calculation module

32 microdata collection management module

34 big data tabulation module

36 member database

38 central database

40 branch database

42 branch database

44 branch database

What is claimed is:

1. A method of big data product customization and data provider's profits sharing, applied to a data collection and profits sharing system, comprising the following steps:
a governing module of the data collection and profits sharing system receives a data buying and selling request sent from a user terminal, and sends a data buying and selling screen data to the user terminal according to the data buying and selling request;
the governing module receives a data selling request sent from the user terminal, and sends a microdata providing screen data to the user terminal according to the data selling request;
an interests calculation module of the data collection and profits sharing system receives a consumption microdata sent from the user terminal, verifies whether the consumption microdata conforms to a specified data format, and stores the consumption microdata in a personal microdata account of a microdata collection management module of the data collection and profits sharing system;
the interests calculation module classifies the verified consumption microdata according to a predetermined classification code, and stores the classified consumption microdata in a branch database, corresponding to the classified consumption microdata, among a plurality of branch databases of a central database of the data collection and profits sharing system; and
the interests calculation module evaluates the consumption microdata to give an interests value, and stores the interests value in a personal interests account of a supplier's interests and profits sharing module of the data collection and profits sharing system.

2. The method according to claim 1, wherein before the governing module receives a data buying and selling request sent from the user terminal, the method comprises the following steps:
the governing module receives a new member join request sent from the user terminal, and sends a membership term screen data to the user terminal according to the new member join request;
the governing module receives an authorization message sent from the user terminal, and sends a member registration screen data to the user terminal according to the authorization message; and
the governing module receives a member data sent from the user terminal, verifies the member data, writes a member number corresponding to the member data, and stores the member number and the corresponding member data to a member database of the data collection and profits sharing system.

3. The method according to claim 2, wherein the member data comprises name, birth date, identity card number, gender, address, phone number and email account.

4. The method according to claim 1, wherein after the interests calculation module evaluates the consumption microdata to give an interests value, the method comprises the following steps:
the governing module receives a data buying request sent from the user terminal, and sends a big data product demand screen data to the user terminal according to the data buying request;
the big data cost estimation module of the data collection and profits sharing system receives a product feedback condition data sent from the user terminal, searches a consumption microdata conforming to the product feedback condition data in the central database, calculates the number of the conforming consumption microdata that constitutes a big data product, evaluates the value of the big data product according to the number of the consumption microdata to obtain a big data value amount, and sends the number and value amount of the big data product to the user terminal;
the financial management module of the data collection and profits sharing system transmits a payment completion message to the big data cost estimation module, and the big data cost estimation module transmits the big data product to a big data tabulation module of the data collection and profits sharing system according to the payment completion message;
the big data tabulation module makes each data of the big data product into a product analysis spreadsheet and a product analysis chart, and sends the product analysis spreadsheet and the product analysis chart to the user terminal; and
the big data cost estimation module calculates a profits sharing interests value obtained from the consumption microdata that constitutes the big data product according to the evaluated big data value amount, and sends it to the personal interests account, corresponding to the consumption microdata, of the supplier's interests and profits sharing module.

5. The method according to claim 4, wherein the product feedback condition data comprises consumption region, consumer number, consumption type, consumption amount, consumer age and consumer gender.

6. The method according to claim 4, wherein when a little or none consumption microdata conforming to the product feedback condition data is searched from the central database, the big data cost estimation module sends a special request condition data to the user terminal, and receives the consumption microdata conforming to the special request condition data from the user terminal, wherein the special request condition data comprises one or more of consumption region, consumer number, consumption type, consumption amount, consumer age and consumer gender.

7. The method according to claim 1, wherein the consumption microdata sent from the user terminal is sent in a data format or a photo, and the consumption microdata comprises multiple or all of consumption time, consumption location, consumption pattern, consumption content, consumption amount and consumption quantity.

8. The method according to claim 1, wherein the predetermined classification code is a harmonized system code.

9. A method of big data product customization and data provider's profits sharing, applied to a data collection and profits sharing system, comprising the following steps:
a governing module of the data collection and profits sharing system receives a data buying request sent from a user terminal, and sends a big data product demand screen data to the user terminal according to the data buying request;
a big data cost estimation module of the data collection and profits sharing system receives a product feedback condition data sent from the user terminal, searches a consumption microdata conforming to the product feedback condition data in a central database of the data collection and profits sharing system, calculates the number of the consumption microdata that constitutes a big data product, evaluates the value of the big data product according to the number of the consumption microdata to obtain a big data value amount, and sends the number and value amount of the big data product to the user terminal;
the financial management module of the data collection and profits sharing system transmits a payment completion message to the big data cost estimation module, and the big data cost estimation module transmits the big data product to a big data tabulation module of the data collection and profits sharing system according to the payment completion message;
the big data tabulation module makes each data of the big data product into a product analysis spreadsheet and a product analysis chart, and sends the product analysis spreadsheet and the product analysis chart to the user terminal; and
the big data cost estimation module calculates a profits sharing interests value obtained from the consumption microdata that constitutes the big data product according to the evaluated big data value amount, and sends it to a personal interests account, corresponding to the consumption microdata, of the supplier's interests and profits sharing module of the data collection and profits sharing system.

10. The method according to claim 9, wherein the product feedback condition data comprises consumption region, consumer number, consumption type, consumption amount, consumer age and consumer gender.

11. The method according to claim 9, wherein when a little or none consumption microdata conforming to the product feedback condition data is searched from the central database, the big data cost estimation module sends a special request condition data to the user terminal, and receives the consumption microdata conforming to the special request condition data from the user terminal, wherein the special request condition data comprises one or more of consumption region, consumer number, consumption type, consumption amount, consumer age and consumer gender.

12. The method according to claim 9, wherein before the governing module receives the data buying request sent from the user terminal, the method comprises the following steps:
the governing module receives a new member join request sent from the user terminal, and sends a membership term screen data to the user terminal according to the new member join request;
the governing module receives an authorization message sent from the user terminal, and sends a member registration screen data to the user terminal according to the authorization message; and
the governing module receives a member data sent from the user terminal, verifies the member data, writes a member number corresponding to the member data, and stores the member number and the corresponding member data to a member database of the data collection and profits sharing system.

13. The method according to claim 12, wherein the member data comprises name, birth date, identity card number, gender, address, phone number and email account.

14. The method according to claim 9, wherein before the governing module receives the data buying request sent from the user terminal, the method comprises the following steps:
the governing module receives a data buying and selling request sent from the user terminal, and sends a data buying and selling screen data to the user terminal according to the data buying and selling request;
the governing module receives a data selling request sent from the user terminal, and sends a microdata providing screen data to the user terminal according to the data selling request;
the interests calculation module of the data collection and profits sharing system receives the consumption microdata sent from the user terminal, verifies whether the consumption microdata conforms to a specified data format, and stores the consumption microdata in a personal microdata account of the microdata collection management module of the data collection and profits sharing system;
the interests calculation module classifies the verified consumption microdata according to a predetermined classification code, and stores the classified consumption microdata in a branch database, corresponding to the classified consumption microdata, among a plurality of branch databases of the central database; and
the interests calculation module evaluates the consumption microdata to give an interests value, and stores the interests value in the personal interests account of the supplier's interests and profits sharing module.

15. The method according to claim 14, wherein the consumption microdata sent from the user terminal is sent in a data format or a photo, and the consumption microdata comprises multiple or all of consumption time, consumption location, consumption pattern, consumption content, consumption amount and consumption quantity.

16. The method according to claim 14, wherein the predetermined classification code is a harmonized system code.
